(19) United States
(12) Patent Application Publication
(10) Pub. No.: US 2018/0171088 A1
(43) Pub. Date: Jun. 21, 2018

(54) COATINGS WITH MICROSTRUCTURED SURFACES AND USE THEREOF IN DASHBOARDS, SWITCHING CONSOLES AND OPERATING PANELS

(71) Applicant: MANKIEWICZ GEBR. & CO. GMBH & CO. KG, HAMBURG (DE)

(72) Inventor: UMBERTO DE ROSSI, NORDERSTEDT (DE)

(73) Assignee: MANKIEWICZ GEBR. & CO. GMBH & CO. KG, HAMBURG (DE)

(21) Appl. No.: 15/738,125

(22) PCT Filed: Jul. 6, 2016
(86) PCT No.: PCT/DE2016/100298

§ 371 Date: Dec. 20, 2017

(30) Foreign Application Priority Data
Jul. 7, 2015 (DE) 10 2015 110 947.6

(51) Int. Cl. C08J 7/04; C08J 3/28; C09D 11/101; C09D 11/322; B41M 5/00; B05D 3/06; B41M 3/00

(52) U.S. Cl. CPC C08J 7/047; C08J 3/28; C09D 11/101; C09D 11/322; B05D 1/26; B41M 5/0064; B05D 3/067; B41M 3/00; B41M 5/0047

(57) ABSTRACT

A coated substrate includes a finger-guiding haptics with an outer surface. The outer surface has at least two microstructured regions each of which has a sliding friction coefficient which are respectively different from each other, and at least one of a running elevation and a running depression which are parallel.

### CROSS REFERENCE TO PRIOR APPLICATIONS

This application is a U.S. National Phase application under 35 U.S.C. § 371 of International Application No. PCT/DE2016/100298, filed on Jul. 6, 2016 and which claims benefit to German Patent Application No. 10 2015 110 947.6, filed on Jul. 7, 2015. The International Application was published in German on Jan. 12, 2017 as WO 2017/005249 A1 under PCT Article 21(2).

### FIELD

The present invention relates to coatings with a particular finger-guiding haptics, which, when the surface is touched, directs the fingers or touch movements of the fingers in a preferred direction. The present invention also relates to the use of these surfaces in dashboards, switch consoles or operating panels for improving manual operability.

### BACKGROUND

In vehicles such as, for example, automobiles, switch consoles and switch groups are increasingly used which are very flat for functional or design reasons. The risk of confusion is very high since many switches are often arranged next to each other. Choosing the right button also requires the driver's attention, which can prove risky in road traffic. The switches are usually employed in corresponding depressions or elevations in the dashboard in order to improve operability. However, these have a certain space requirement, which is not always available for technical reasons or is not desired for aesthetic reasons.

The use of microstructured surfaces for generating optical effects by light diffraction and interference has previously been described. WO 2000/30869 describes a process for the production of decorative coatings, whereby a microstructured surface is produced which has holographic effects, color flop or antireflection. To prepare these surfaces, a coating material, for example, a basecoat or a clearcoat, is applied to a substrate. In the still soft, uncured layer, pre-matrices are pressed which emboss the desired pattern into the layer. A correspondingly structured surface is obtained after the layer has hardened.

### SUMMARY

An aspect of the present invention is to provide improved components with elements such as switches and regulators which are required for operating a machine or an apparatus, in particular simple-to-operate flat components such as dashboards, switch consoles or operating panels.

In an embodiment, the present invention provides a coated substrate which includes a finger-guiding haptics comprising an outer surface. The outer surface comprises at least two microstructured regions, each of which comprise a sliding friction coefficient which are respectively different from each other, and at least one of a running elevation and a running depression which are parallel.

### BRIEF DESCRIPTION OF THE DRAWINGS

The present invention is described in greater detail below on the basis of embodiments and of the drawings in which:

FIG. 1 shows a schematic structure of a finger-guiding microstructured surface according to the present invention; and

FIG. 2 shows a schematic structure of a finger-guiding microstructured surface according to the present invention.

### DETAILED DESCRIPTION

The coatings according to the present invention comprise surfaces which have different sliding friction coefficients depending on the direction. When touching a surface, for example with fingers, different forces must be applied depending on the direction, which results in an involuntary contact in the direction of the least force. The contact is thereby guided in a certain direction. This effect is referred to hereafter as “finger guidance”.

According to the present invention, the coatings have microstructures on their outer surface in at least one region which exhibit other haptic properties, in particular a different sliding friction. Depending on the respective arrangement of the control elements such as controllers, pushbuttons, buttons or switches, the coating may have different patterns. The surface may thus, for example, exhibit a lower sliding friction along an axis which leads to the control elements and have a higher sliding friction perpendicular to the axis.

According to the present invention, patterns are used which combine straight lines for “catching the finger” with curved lines so that the finger is guided directly towards the relevant control element.

According to the present invention, the microstructures are mounted on the outer surface of a coated substrate, the patterns being formed on the uppermost or outermost layer before curing. This outer layer can be part of a coating system in a single layer and multilayer construction. UV-curing coating materials such as clear lacquers, color lacquers or inkjet inks can, for example, be used. The UV-curing coating materials used contain, for example, from 5 to 90% of binder, based on the mass of the coating material. Suitable binders are, for example, oligomers such as aliphatic and aromatic urethane acrylates, polyether acrylates and epoxy acrylates, wherein the acrylates may be mono- or polyfunctional, for example, di-, tri- up to hexa and deca-functional, dipropylene glycol diacrylate, tripropylene glycol diacrylate, tetrahydrofurfuryl acrylate, isobornyl acrylate, isodecyl acrylate, and mixtures thereof. The coating materials can also contain one or more pigments, for example, Pigment Yellow 213, PY 151, PY 93, PY 83, Pigment Red 122, PR 168, PR 254, PR 179, Pigment Red 166, Pigment Red 48:2, Pigment Violet 19, Pigment Blue 15:1, Pigment Blue 15:3, Pigment Blue 15:4, Pigment Green 7, Pigment Green 36, Pigment Black 7 and Pigment White 6. Further additives can also be added to the coating materials for adjusting their properties, for example, dispersing additives, defoamers, photoinitiators and UV absorbers.

The microstructures according to the present invention can be produced, for example, by embossing processes with a negative die or by an inkjet printing processes.

In an embodiment of the present invention, the microstructured surfaces can, for example, be obtained by embossing the above-mentioned patterns with a negative matrix into the outer layer. A UV curing coating agent is first used, for example, a UV clear or a color varnish. Customary application procedures known to a person skilled in the art, for example, spraying, injecting, brushing, roller coating, rolling or dipping can thereby be used. After application, emboss matrices are pressed with their relief side into the uncured, applied layer. The embossing matrices are made of materials suitable for application, such as, for example, silicone plastic. The layer is subsequently at least partially cured by irradiation. The emboss matrices are then removed and the layer is, optionally, completely cured.

In an embodiment of the present invention, microstructured surfaces can, for example, be obtained by applying the above-mentioned patterns as an upper or outer layer by inkjet printing processes. For this purpose, a clear varnish or a pigmented varnish, which is inkjet-compatible, is passed over a print head customary for industrial applications, for example, printing heads from companies like Konica, Kyocera or Dimatix, by inkjet printing. The application is performed by inkjet printing in the desired structure so that no further matrix is necessary. For an increase in the layer thickness, several heads can print the same grid or the printing process is repeated until the desired profile height is reached. This type of application can be combined with a primer or a topcoat layer in order to improve the properties of the coating such as the substrate adhesion or the surface resistance.

According to the present invention, plastic substrates are used which are produced, for example, from acrylic-butadiene-styrene copolymer (ABS), acrylic-butadiene-styrene copoly merisate/polycarbonate (ABS/PC), polycarbonate (PC), polypropylene (PP), polyethylene (PE) or polyethylene terephthalate (PET). According to the present invention, substrates made of acrylic-butadiene-styrene copolymerisate (ABS), acrylic-butadiene-styrene copolymerisate/polycarbonate (ABS/PC) or polycarbonate can, for example, be used.

Due to the particular haptic properties, the substrates coated according to the present invention are characterized by a finger guidance. They are therefore particularly well suited as an aid to the manual operation of regulators or pushbuttons, which are arranged in a large number close together, such as, for example, in control panels, switch consoles and dashboards of vehicles. In an embodiment of the present invention, the coated substrates, which have at least two microstructured regions with different sliding friction coefficients on their surface, can be used as carriers or cladding of control elements for the machine control. They in particular are used as dashboards, switch consoles and operating panels in vehicles, for example, in automobiles.

In the case of pushbuttons or switches arranged very close to one another, it is difficult to find a particular key without visual contact. The danger of pushing another key by mistake is comparatively great with this arrangement. The coating of the panel according to the present invention has a lower sliding friction in selected regions around the individual keys in the direction of movement of the fingers than on the other surfaces. A corresponding movement of the fingers along the surface is therefore substantially easier within these surfaces. The movement is therefore guided involuntarily. The fingertip can be placed in a much larger area and is oriented directly towards the key.

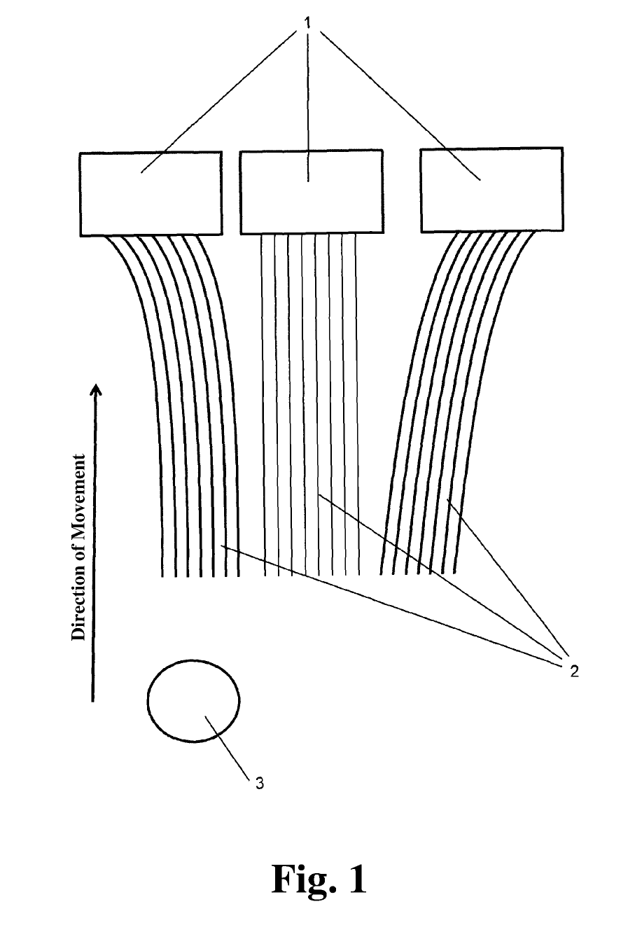

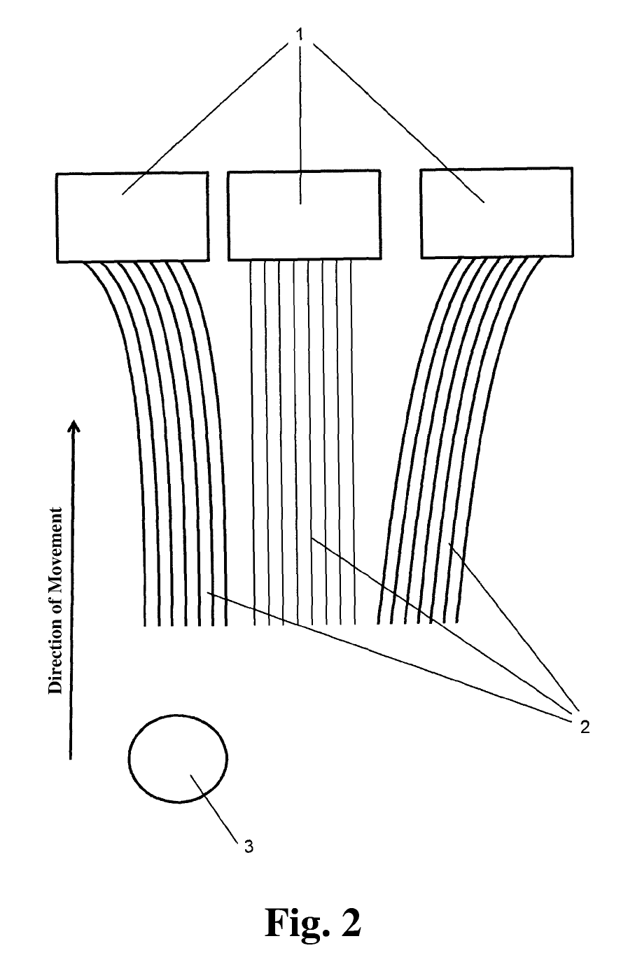

FIGS. 1 and 2 show the schematic structure of a finger-guiding microstructured surface according to the present invention. At a certain distance from the keys or switches (1) to be operated, parallel microstructures (2) begin, which are obtained by elevations or depressions leading to the individual keys (1), such as, for example, grooves or beads. When the fingertip (3) is placed on the surface around the keys (1) and moved in the direction of the keys (1), the movement of the fingertip (3) is directed in a preferred direction, namely towards the keys (1) by the different adhesion friction on the microstructured (2) and the smooth regions of the surface.

### EXAMPLES

### Example Formulation 1

| | Proportion |
|---|---|
| | [% in weight] |
| SR 506D (Isobornyl acrylate) | 55 |
| Ebercryl 1290 (aliphatic urethane acrylate) | 32 |
| Byk 378 (Silicone surface additive) | 2 |
| Irgacure 184 (Photoinitiator) | 6 |
| Butyl acetate (solvent) | 5 |

### Production of the Patterns

The formulation was applied with a roller to a defined range and was briefly vented at room temperature. A matrix made of silicone was pressed onto the surface over a period of 5 minutes and cured with an ultraviolet lamp (Fusion LH6, Hg spotlight) with an intensity of 500 mW/cm² and a dose of 1500 mW/cm² during the exposure time. After curing, the matrix was carefully peeled off. The surface was immediately ready for use after curing.

### Example Formulation 2

| | Proportion |
|---|---|
| | [% in weight] |
| Binder Component | |
| Genomer 4690 (aliphatic urethane acrylate) | 40 |
| CN 133 (aliphatic triacrylate oligomer) | 20 |
| SR 399 (Di-pentaerythritol pentaacrylate) | 15 |
| Macrynal SM 510 (OH-functional acrylate resin) | 18 |
| Byk 378 (Silicone surface additive) | 2 |
| Irgacure 184 (Photoinitiator) | 5 |
| Hardener Component | |
| Desmodur N3900 (aliphatic polyisocyanate resin | 100 |
| on the basis of hexamethylene diisocyanate) | |

The binder component and hardener component were mixed in the ratio 4:1. The mixture was applied with a roller within a defined range. Within 1 minute, a matrix made of silicone was pressed onto the surface and fixed with a UV lamp (Fusion LH6, Hg spotlight) with an intensity of 200 mW/cm² and a dose of 700 mW/cm² during the exposure time. The matrix was then carefully peeled off and the surface was thermally post-cured at 60° C. for 30 minutes. The surface was immediately ready for use after thermal curing.

The present invention is not limited to embodiments described herein; reference should be had to the appended claims.

What is claimed is:

1-9. (canceled)

10. A coated substrate comprising:
a finger-guiding haptics comprising an outer surface, the outer surface comprising at least two microstructured regions each of which comprise,
a sliding friction coefficient which are respectively different from each other, and
at least one of a running elevation and a running depression which are parallel.

11. The coated substrate as recited in claim 10, wherein the outer surface is made of a UV-curing coating material.

12. The coated substrate as recited in claim 11, wherein the UV-curing coating material is a UV-curing paint.

13. The coated substrate as recited in claim 11, wherein the UV-curing coating material is a UV-curing inkjet ink.

14. A method of coating a substrate so as to provide the coated substrate as recited in claim 11, the method comprising:
applying microstructures to the UV-curing coating material to provide the at least two microstructured regions.

15. The method as recited in claim 14, wherein,
the UV-curing coating material is a UV-curing paint, and
the microstructures are applied to the UV-curing paint via an embossing processes with a negative matrix.

16. The method as recited in claim 14, wherein,
the UV-curing coating material is a UV-curing inkjet ink, and
the microstructures are applied from the UV-curing ink via an inkjet printing.

17. A method of using a coated substrate comprising:
a finger-guiding haptics comprising an outer surface, the outer surface comprising at least two microstructured regions each of which comprise,
a sliding friction coefficient which are respectively different from each other, and
at least one of a running elevation and a running depression which are parallel, the method comprising:
providing the coated substrate; and
using the coated substrate as a carrier or as a cladding of a control element for the control of at least one of a device, a machine and an apparatus.

18. The method of using as recited in claim 17, wherein the carrier or the cladding of the control element is a dashboard, a switch console, or an operating panel in a vehicle.

19. The method of using as recited in claim 18, wherein the vehicle is an automobile.
